(19) United States
(12) Patent Application Publication
(10) Pub. No.: US 2016/0041800 A1
(43) Pub. Date: Feb. 11, 2016

(54) USER INTERFACE FOR LABEL PRINTER

(71) Applicant: SANFORD LP, Downers Grove, IL (US)

(72) Inventors: Ron Jacobs, Acworth, GA (US); Stephen Charles Gohde, Atlanta, GA (US); Stephen Spencer, Atlanta, GA (US); Bram Boot, Borgerhout (BE); Latha Airodi, Suwanee, GA (US); Nancy Elaine Taylor, Lawrenceville, GA (US); David G. Nesfeder, JR., Gainesville, GA (US)

(21) Appl. No.: 14/777,367

(22) PCT Filed: Mar. 14, 2014
(86) PCT No.: PCT/EP2014/055200

§ 371 Date: Sep. 15, 2015

Related U.S. Application Data
(60) Provisional application No. 61/787,125, filed on Mar. 15, 2013.

(51) Int. Cl. G06F 3/12; G06F 17/21; G06F 3/0486

(52) U.S. Cl. CPC G06F 3/1253; G06F 3/0486; G06F 3/1208; G06F 3/1284; G06F 17/212; G06F 3/1256

(57) ABSTRACT

A method comprising: providing in a first region of a user interface a label preview region for displaying an image of at least one label to be printed; providing in a second region of the user interface a data input area comprising two or more cells for input label data; wherein each cell in the data input area corresponds with the image of at least one label to be printed or at least one region of the image of at least one label to be printed.

### CROSS-REFERENCE TO RELATED APPLICATION

The present application is the US national phase of International Patent Application No. PCT/EP2014/055200, filed Mar. 14, 2014, which application claims priority to U.S. 61/787,125, filed Mar. 15, 2013. The priority application, U.S. 61/787,125, is hereby incorporated by reference.

### BACKGROUND

Some embodiments relate to a user interface of a label printer for printing an image onto a label.

Known label printing apparatuses are disclosed in EP-A-322918 and EP-A-322919 (Brother Kogyo Kabushiki Kaisha) and EP-A-267890 (Varitronic). The label printing apparatuses each include a cassette receiving bay for receiving a cassette or tape holding case. In EP-A-267890, the tape holding case houses an ink ribbon and a substrate tape, the latter comprising an upper image receiving layer secured to a backing layer by an adhesive. In EP-A-322918 and EP-A-322919, the tape holding case houses an ink ribbon, a transparent image receiving tape and a double sided adhesive tape which is secured at one of its adhesive coated sides to the image tape after printing and which has a backing layer peelable from its other adhesive coated side. With both these apparatus, the image transfer medium (ink ribbon) and the image receiving tape (substrate) are in the same cassette.

It has also been proposed by the present applicants in, for example, EP-A-578372 to house the ink ribbon and the substrate tape in separate cassettes.

In all of these cases, the image receiving tape passes in overlap with the ink ribbon to a print zone consisting of a fixed print head and a platen against which the print head can be pressed to cause an image to transfer from the ink ribbon to the image receiving tape. There are many ways of doing this, including dry lettering or dry film impression, but the most usual way currently is by thermal printing where the print head is heated and the heat causes ink from the ink ribbon to be transferred to the image receiving tape.

In other known tape printing apparatuses, so-called direct thermal tapes are used, in which an image is created directly onto the direct thermal tape without the interposition of an ink ribbon cassette. Elements of a print head are heated, and the heat causes chemicals within the direct thermal tape to react and produce an image in or on the tape.

The apparatuses of the type described above are provided with a keyboard which enables a user to enter characters, symbols and the like to form an image to be printed by the tape printer. The keyboard usually has text character keys and number keys for entering letters and numbers respectively, plus some function keys which, among other things, operate menus and allow printing attributes to be set.

“Stand-alone” label printers can be distinguished from “label printer systems”, which comprise a printer connected to a PC or other computing device. In such label printer systems, a user creates or edits a label for printing using a PC, and then sends print data to a printer to cause the printer to print the print data onto a label medium. In such label printer systems, the user will view a display of the PC to create a label, rather than a display of the printer. Also, the label-editing software used for creating the label will be stored and run on the PC, rather than the printer.

In contrast, stand-alone label printers are operable independently of a PC or other computer to create and print a label. Although some stand-alone printers are connectable to a PC or other computer to receive some data, they are nevertheless operable independently of the PC or other computer to create a label for printing, since label-editing software used for creating the label is stored and run on the label printer itself. Stand-alone label printers thus usually include an integral display via which the user can view an interface of the label-editing software.

### SUMMARY

According to a first aspect there is provided a method comprising: providing in a first region of a user interface a label preview region for displaying an image of at least one label to be printed; providing in a second region of the user interface a data input area comprising two or more cells for input label data; wherein each cell in the data input area corresponds with the image of at least one label to be printed or at least one region of the image of at least one label to be printed.

Preferably the method comprises mapping data entered in the data input area to the corresponding image of at least one label to be printed or at least one region of the image of at least one label to be printed.

Preferably the mapped data is located in said image of at least one label to be printed or at least one region of the image of at least one label to be printed in dependence on the cell corresponding with that data.

Preferably the method comprises transferring, in response to an input to a user-input, data entered in the data input area to the corresponding image of at least one label to be printed or at least one region of the at least one label to be printed.

Preferably the user-input comprises a dragging and dropping operation.

Preferably when a cell is specified via a user input, at least one of that cell, and the corresponding image of at least one label or at least one region of the image of the at least one label, are highlighted.

Preferably when the image of at least one label or at least one region of the image of the at least one label is specified by an input to a user input, at least one of that image of at least one label or at least one region of the image of the at least one label, and a corresponding one or more cells, are highlighted.

Preferably said highlighting comprises at least one of a colored background, a shaded background, a flashing background.

Preferably specifying by a user comprises selecting with a selector, or hovering over with a selector, either of the image of at least one label or at least one region of the image of the at least one label, or at least one cell.

Preferably the two or more cells are arranged in a table structure comprising rows and columns, wherein one of each column and each row corresponds with one label or group of labels.

Preferably the method comprises enabling by an input to a user input adding or removing of at least one of a row and a column in said table structure.

Preferably the method comprises one or both of importing data from an external program in to said data input area and exporting data from said data input area to an external program.

The two or more cells may be arranged in a table structure comprising rows and columns, each column being provided with header information.

When a cell is highlighted the corresponding column header may be highlighted.

The method may comprise providing an information input area, said information input area enabling a user to enter information for defining a serialized pattern of data for at least one label to be printed; wherein said method comprises populating each of said two or more cells with a portion of said serialized pattern of data

In a further aspect there is provided a computer program comprising computer program code means adapted to perform the method described above when said program is run on a computer.

In a further aspect there is provided an apparatus comprising: a controller configured: to output, to a display driver, data for causing the display driver to drive a display to display in a first region of a user interface a label preview region for displaying at least one label to be printed; and to display in a second region of the user interface a data input area comprising two or more cells for input label data; wherein the controller is configured to correspond each cell in the data input area with the image of at least one label to be printed or at least one region of the image of the at least one label to be printed.

Preferably the controller is configured to automatically map data entered in the data input area to the corresponding image of at least one label to be printed or at least one region of the image of at least one label to be printed.

Preferably the controller is configured to locate the automatically mapped data in said image of at least one label to be printed or at least one region of the image of at least one label to be printed in dependence on the cell corresponding with that data.

Preferably the controller is configured, in response to user-input, to transfer data entered in the data input area to the corresponding image of at least one label to be printed or at least one region of the image of the at least one label to be printed.

Preferably the user-input comprises a dragging and dropping operation.

Preferably when a cell is specified by a user, the controller is configured to highlight that cell and the corresponding image of at least one label or at least one region of the image of the at least one label.

Preferably when the image of at least one label or at least one region of the image of the at least one label is specified by a user, the controller is configured to highlight that image of at least one label or at least one region of the image of the at least one label and a corresponding one or more cells.

Preferably said highlight comprises at least one of a colored background, a shaded background, a flashing background.

Preferably specifying by a user comprises selecting with a selector, or hovering over with a selector, either of the image of at least one label or at least one region of the image of the at least one label, or at least one cell.

Preferably the controller is configured to cause the two or more cells to be displayed in a table structure comprising rows and columns, wherein one of each column and each row corresponds with one label or group of labels.

The controller may be configured to cause the two or more cells to be displayed in a table structure comprising rows and columns, each column being provided with header information.

The controller may be configured when a cell is highlighted to cause the corresponding column header to be highlighted.

Preferably the apparatus is configured to enable a user to add or remove at least one of a row and a column in said table structure.

Preferably the apparatus is configured to enable a user to one or both of import data from an external program in to said data input area and export data from said data input area to an external program.

The controller may be configure to provide an information input area, said information input area enabling a user to enter information for defining a serialized pattern of data for at least one label to be printed; wherein said method comprises populating each of said two or more cells with a portion of said serialized pattern of data

Preferably said apparatus comprises one of a label printer and a PC.

In a further aspect there is provided a method comprising: providing in a first region of a user interface an information input area, said information input area enabling a user to enter information for defining a serialized pattern of data for at least one label to be printed; providing in a second region of the display a table comprising two or more cells; and wherein said method comprises populating each of said two or more cells with a portion of said serialized pattern of data.

Preferably said table comprises at least one row of cells.

Preferably said table comprises at least one column of cells.

Preferably said serialized pattern of data populates a plurality of rows of cells.

Preferably said serialized pattern of data populates a plurality of columns of cells.

Preferably if said table is too large to be displayed in said preview area simultaneously, scroll bars are provided to enable a user to scroll around said second region.

Preferably said serialized pattern of data comprises two or more alphanumeric characters, and said method comprises enabling a user to serialize each of said two or more alphanumeric characters.

Preferably said method comprises enabling a user to specify the manner in which each of said two or more alphanumeric characters is serialized.

In a further aspect there is provided a computer program comprising computer program code means adapted to perform the method described above when said program is run on a computer.

In a further aspect there is provided an apparatus comprising: a controller configured: to output, to a display driver, data for causing the display driver to drive a display to display in a first region of a user interface an information input area, said information input area configured to enable a user to enter information for defining a serialized pattern of data for at least one label to be printed; and to display in a second region of the display a table comprising two or more cells; and wherein said controller is configured to populate each of said two or more cells with a portion of said serialized pattern of data.

Preferably said table comprises at least one row of cells.

Preferably said table comprises at least one column of cells.

Preferably said controller is configured to populate a plurality of rows of cells with said serialized pattern of data.

Preferably said controller is configured to populate a plurality of columns of cells with said serialized pattern of data.

Preferably if said table is too large to be displayed in said preview area simultaneously, scroll bars are provided to enable a user to scroll around said second region.

Preferably said serialized pattern of data comprises two or more alphanumeric characters, and said apparatus is configured to enable a user to serialize each of said two or more alphanumeric characters.

Preferably said apparatus is configured to enable a user to specify the manner in which each of said two or more alphanumeric characters is serialized.

In a further aspect there is provided a method comprising: providing a user with one or more functions for creating a label to be printed, said one or more functions comprising a recall function; wherein when said user selects said recall function, data from a previously created label is recalled and made available to a user for insertion in to a new label; wherein said new label is of a different type to said previously created label.

Preferably said new label and said previously created label each comprise one of: a general label; a cable wrap label; a 110-block label; a patch panel label; a horizontal breaker label; an asset-tracking label; a heat-shrink label; an arc-flash label; a flag label; a distribution panel label; a terminal block label; a vertical breaker label; a pipe marking label; a self-laminating cable wrap label; a right-to-know label.

Preferably said previously created label comprises two or more defined information areas.

Preferably said new label comprises two or more defined information areas.

Preferably said method comprises inserting said recalled data in to said two or more defined information areas of said new label.

Preferably prior to inserting said recalled data in to said new label, said method comprises providing a user with options regarding a layout of the data in the new label.

Preferably said method comprises providing a user interface comprising a label preview region and a data-input region.

Preferably said data input region comprises a table comprising two or more cells.

Preferably said method comprises displaying said recalled data in said table.

Preferably prior to recalling said data, said method comprises determining whether said recalled data is compatible with said new label.

In a further aspect there is provided a computer program comprising computer program code means adapted to perform the method described above when said program is run on a computer.

In a further aspect there is provided an apparatus comprising a controller configured:

to output, to a display driver, data for causing the display driver to drive a display to display to a user one or more functions for creating a label to be printed, said one or more functions comprising a recall function; wherein said controller is configured to, in response to selection of said recall function by said user, recall data from a previously created label and make that recalled data available to a user for insertion in to a new label; wherein said new label is of a different type to said previously created label.

Preferably said new label and said previously created label each comprise one of: a general label; a cable wrap label; a 110-block label; a patch panel label; a horizontal breaker label; an asset-tracking label; a heat-shrink label; an arc-flash label; a flag label; a distribution panel label; a terminal block label; a vertical breaker label; a pipe marking label; a self-laminating cable wrap label; a right-to-know label.

Preferably said previously created label comprises two or more defined information areas.

Preferably said new label comprises two or more defined information areas.

Preferably said controller is configured to insert said recalled data in to said two or more defined information areas of said new label.

Preferably prior to inserting said recalled data in to said new label, said controller is configured to provide a user with options regarding a layout of the data in the new label.

Preferably said controller causes the display driver to drive the display to display a user interface comprising a label preview region and a data-input region.

Preferably said data input region comprises a table comprising two or more cells.

Preferably said controller causes the display driver to display said recalled data in said table.

Preferably prior to recalling said data, said controller is configured to determine whether said recalled data is compatible with said new label.

In a further aspect there is provided a method comprising: providing in a first region of a user interface a label preview region for displaying an image of at least one label to be printed; providing in a second region of the user interface a data input area comprising two or more cells for input label data; wherein each cell in the data input area corresponds with the image of at least one label to be printed or at least one region of the image of at least one label to be printed; and wherein when one of said cells or said image of at least one label to be printed or at least one region of the image of at least one label to be printed is specified by a user, the specified cell or specified image of at least one label to be printed or at least one region of the image of at least one label to be printed is highlighted, and the corresponding cell or image of at least one label to be printed or at least one region of the image of at least one label to be printed is also highlighted.

In a further aspect there is provided a computer program comprising computer program code means adapted to perform the method described above when said program is run on a computer.

In a further aspect there is provided an apparatus comprising: a controller configured: to output, to a display driver, data for causing the display driver to drive a display to display in a first region of a user interface a label preview region for displaying at least one label to be printed; and to display in a second region of the user interface a data input area comprising two or more cells for input label data; wherein the controller is configured to correspond each cell in the data input area with the image of at least one label to be printed or at least one region of the image of the at least one label to be printed; and wherein when one of said cells or said image of at least one label to be printed or at least one region of the image of at least one label to be printed is specified by a user, the controller is configured to cause the specified cell or specified image of at least one label to be printed or at least one region of the image of at least one label to be printed to be highlighted, and the controller being configured to cause the corresponding cell or image of at least one label to be printed or at least one region of the image of at least one label to be printed to also be highlighted.

In a further aspect, there is provided a method comprising: providing an information input area, said information input area enabling a user to enter information for defining data for at least one label to be printed; displaying responsive to a selection of a serialization option, serialization option information comprising one or more of: data for serialization; a count value; and an increment value; and applying serialization to said data for serialization and displaying said serialized data.

The method may comprise displaying said serialization option information for a plurality of different data to be serialized, side by side.

The method may comprise serializing each of said plurality of different data for each successive serialized data.

The method may comprise serializing one of said plurality of data to the end of its respective count, serializing another one of said plurality of data by one count and repeating the serializing of said one of the plurality of data to the end of its respective count, said steps being repeated until said data has been sequentially serialized.

In a further aspect there is provided an apparatus comprising: a controller configured: to output, to a display driver, data for causing the display driver to drive a display to display: an information input area, said information input area enabling a user to enter information for defining data for at least one label to be printed and to display responsive to a selection of a serialization option, serialization option information comprising one or more of: data for serialization; a count value; and an increment value, said controller being configured to cause said serialization to be applied said data for serialization and to output to said display driver data for driving said display to display said serialized data

The controller may be configured to cause display driver to drive the display to display said serialization option information for a plurality of different data to be serialized, side by side.

The controller may be configured to serialize each of said plurality of different data for each successive serialized data.

The controller may be configured to serialize one of said plurality of data to the end of its respective count, serialize another one of said plurality of data by one count and repeating the serializing of said one of the plurality of data to the end of its respective count, said steps being repeated until said data has been sequentially serialized.

### BRIEF DESCRIPTION OF THE FIGURES

Embodiments will now be described, by way of example only, with reference to the accompanying Figures in which:

FIG. 1 is a plan view showing certain parts of one type of label printing system;

FIG. 2 is a plan view showing certain parts of another type of label printing system;

FIG. 3 is a schematic diagram of certain parts of a label printing system;

FIG. 4 shows a user interface according to an embodiment;

FIG. 5 shows a user interface according to an embodiment;

FIG. 6 shows a progression of the user interface of FIG. 5;

FIG. 7 shows a progression of the user interface of FIG. 6;

FIG. 8 shows a progression of the user interface of FIG. 7;

FIG. 9 shows a user interface according to an embodiment;

FIG. 10 shows a user interface associated with the importing of a file;

FIG. 11 shows a user interface according to an embodiment associated with a serialization procedure;

FIG. 12 shows a progression of the user interface of FIG. 11;

FIG. 13 shows a progression of the user interface of FIG. 12;

FIGS. 14 to 18 show a user interface according to an embodiment associated with a feature of recalling data; and

FIGS. 19a to c show another user interface according to an embodiment associated with another serialization procedure.

### DETAILED DESCRIPTION

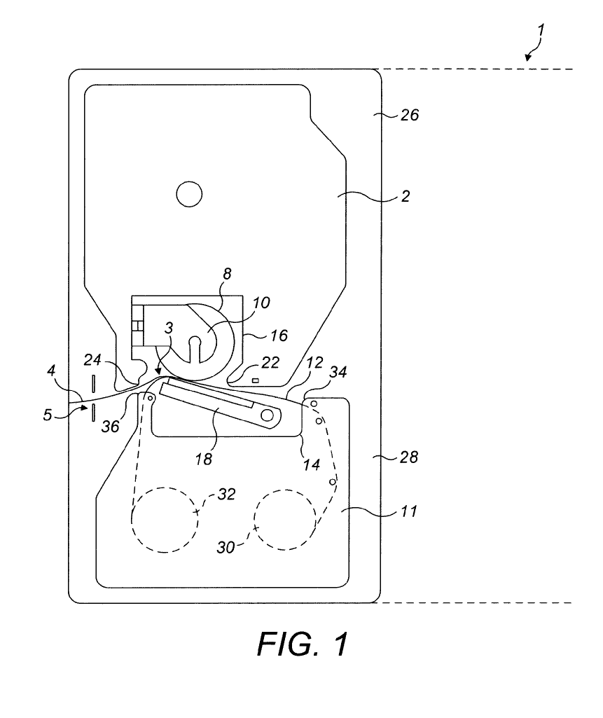

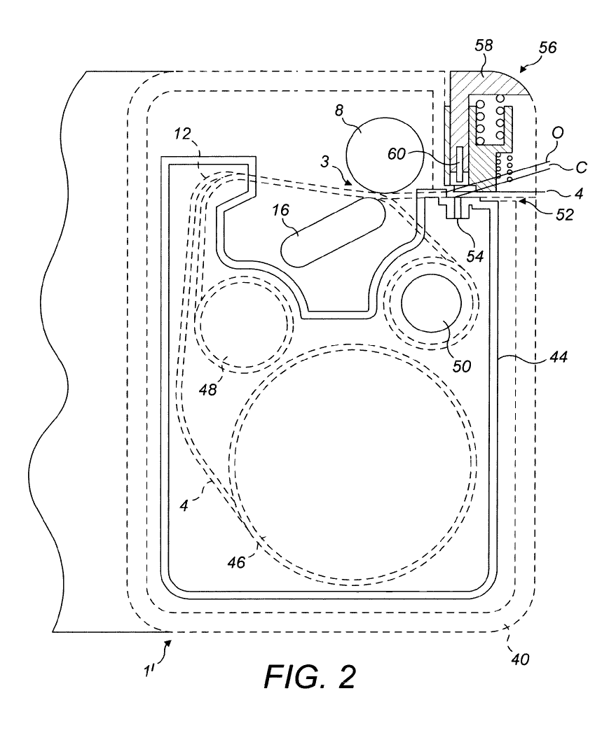

FIG. 1 shows in plan view a first label printer which has two cassettes arranged therein. Typically, this label printer 1 is powered by batteries at least part of the time. Alternatively or additionally the label printer may be mains powered.

The upper cassette is located in a first cassette receiving portion 26 and contains a supply of image receiving tape 4 which passes through a print zone 3 of the label printer 1 to an outlet 5 of the label printer 1. The image receiving tape 4 comprises an upper layer for receiving a printed image on its upper surface and has its other surface coated with an adhesive layer to which is secured a releasable backing layer. It should be appreciated that other types of image receiving tape may be used alternatively or additionally. For example the image receiving tape may be provided with a plurality of die cut labels.

The upper cassette 2 has a recess for accommodating a platen 8 of the label printer 1, and guide portions 22 and 24 for guiding the tape through a print zone 3. The platen 8 is mounted for rotation within a cage moulding 10. Alternatively the platen could be mounted for rotation on a pin.

The lower cassette 11 is located in the second cassette receiving portion 28 and contains a thermal transfer ribbon 12 which extends from the supply spool 30 to a take-up spool 32 within the cassette 11. The thermal transfer ribbon 12 extends through the print zone 3 in overlap with the image receiving tape 4. The cassette 11 has recess 14 for receiving a print head 18 of the label printer 1 and guide portions 34 and 36 for guiding the thermal transfer ribbon 12 through the print zone 3. Print head 18 is moveable between an operative position shown in FIG. 1, in which it is in contact with the platen 8 and holds the thermal transfer ribbon 12 and the image receiving tape 4 in overlap between a print head 18 and the platen 8, and an inoperative position in which it is moved away from the platen 8 to release thermal transfer ribbon 12 and image receiving tape 4. In the operative position, the platen 8 is rotated to cause the image receiving tape 12 to be driven past print head 18 and the print head 18 is controlled to print an image on the image receiving tape 4 by thermal transfer of ink from the ribbon 12. Each of the printing elements on the print head 18 may be activatable separately and is activated in accordance with the desired image to be printed. The label printer 1 has a lid (which is not shown) which is hinged along the rear of the cassette receiving portions 26 and 28 and which covers both cassettes when in place.

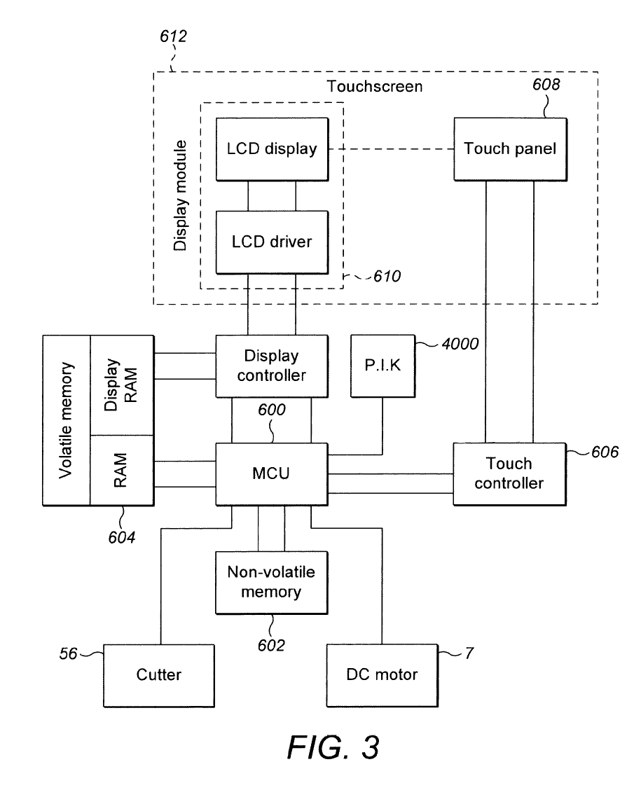

A DC motor 7 (see FIG. 3) continuously drives the platen 8. The platen is arranged to drive the image receiving tape 4 through the print zone 3 by the actuation of its own rotation. In other embodiments, transport of the image receiving tape across the print head can be done by other means, such as by a separate driven roller of the printer or of the cassette, or by a pair of cooperating rollers positioned on opposite sides of the tape, or by other means.

The image is printed by the print head 18 on the image receiving tape on a column by column basis with the columns being adjacent one another in the direction of movement of the tape 4.

FIG. 2 illustrates in plan view a cassette bay of a second label printer 1′ which uses a one cassette system. Like reference numerals are used for those parts which are also shown in FIG. 1. The cassette bay is shown by the dotted line 40. The cassette bay 40 includes a thermal print head 18 and a platen 8 which cooperate to define a print zone 3.

The print head 18 is pivotable about a pivot point so that it can be brought into contact with the platen 8 for printing and moved away from the platen 8 to enable the cassette to be removed and replaced as in the first embodiment. Alternatively the platen is pivotable so that it can be brought into contact with the printhead for printing and moved away from the printhead to enable the cassette to be inserted. A cassette inserted into the cassette bay 40 is denoted generally by reference numeral 44. The cassette 44 holds a supply spool 46 of image receiving tape 4. The image receiving tape 4 is guided by a guide mechanism (which is not shown) through the cassette 44, past the print zone 3 and out of the cassette 44 through an outlet O to a cutting location C. The same cassette 44 also has an ink ribbon supply spool 48 and an ink ribbon take up spool 50. The ink ribbon 12 is guided from the ink ribbon supply spool 48 through the print zone 3 and taken up on the ink ribbon take up spool 50. As with the first embodiment, the image receiving tape 4 passes in overlap with the ink ribbon 12 through the print zone 3 with its image receiving layer in contact with the ink ribbon 12. The platen of this second embodiment is also driven by a motor 7. The motor rotates to drive continuously the image receiving tape through the print zone 3 during printing. In either of the embodiments, it is possible that the tape be driven in a step wise manner by a stepper motor.

An image is printed on the tape fed out from the print zone to the cutting location C which is provided at a location in a portion of the wall of the cassette 44 which is close to the print zone 3. The portion of the wall on the cassette 44 where the cutting location C is defined is denoted by reference 52. A slot 54 is defined in the wall portion 52 and the image receiving tape 4 is fed past the print zone 3 and out of the cassette 44 through an outlet O to the cutting location C where it is supported by facing wall portions on either side of the slot 54.

The second label printing device 1′ includes a cutting mechanism 56 including a cutter support member 58 which carries a blade 60. The blade 60 cuts the image receiving tape 4 and then enters the slot 54. It should be appreciated that the first embodiment will usually also include a cutting mechanism.

These example label printers 1 and 1′ may act as stand-alone printing devices including a controller for receiving inputs from a user and to alter what is displayed on a display of the printing devices. Furthermore, the label printers 1 and 1′ may alternatively or additionally be connectable or connected to a PC, in which case the PC also includes a controller to receive inputs from a user and to alter what is displayed on a display of the printer or of the PC.

Basic circuitry for controlling the label printer 1 of FIG. 1 or the label printer 1′ of FIG. 2 is shown in FIG. 3. There is a controller or “control means” (such as a micro controller unit (MCU) or processor) 600, a non-volatile memory 602 which is for example a read only memory (ROM) or a flash type of memory. The flash type of memory may be used in place of, or in addition to the read only memory. A volatile memory comprising a random access memory RAM 604 and/or display RAM is also provided. The MCU 600 is connected to receive label data input to it from a data input device such as a touch panel 608 of a touchscreen 612 via a touch panel controller 606. In alternative embodiments, the data input device may comprise one or more of a hardware keyboard including plural keys, a mouse, a digital pen or tracker ball, or any other means for enabling a user to send commands to the controller 600. In some embodiments, the touchscreen 612 is omitted. The MCU 600 outputs data to drive the display 610 (which together with the touch panel 608 form the touchscreen 612) to display a label to be printed (or a part thereof) and/or a message for the user. Additionally, the MCU 600 also outputs data to drive the print head 18 so that the label data is printed onto the image receiving tape to form a label. Finally, the MCU 600 also controls the motor 7 for driving the platen. The MCU 600 may also control the cutting mechanism 56 of FIG. 2 or a cutting mechanism of the device shown in FIG. 1 to allow a length of tape to be cut off. In alternative embodiments at least part of the cutting mechanism may be manually operated.

It should also be understood that where the label printer 1 or 1′ is connected to an external apparatus such as a PC, then the PC also contains similar components such as at least one memory and at least one processor to enable the PC to carry out the operations of creating a label to be printed. Such a PC will also be connected to a display means such as a monitor. It should be appreciated that the label printer may be connected to any other suitable device such as a tablet, or mobile phone.

Hereafter it should be understood that labels may be created on either or both of the label printing apparatus itself or on an external apparatus such as a PC connected to the label printer. Accordingly, it shall be understood that hereafter terms such as “memory”, “processor” and “display” may refer to these components on either or both of a label printing apparatus and a PC.

It should be appreciated that the label printers are shown by way of example only. In other embodiments, the ink ribbon may be omitted. In some embodiments, the printer may use a different printing technique to thermal printing, for example ink jet printing or the like. In some embodiments the print head may be fixed and in other embodiments, the platen and print head may both be movable.

The user input device may be provided by any suitable device. The input device may be provided by a keyboard and/or a touch screen.

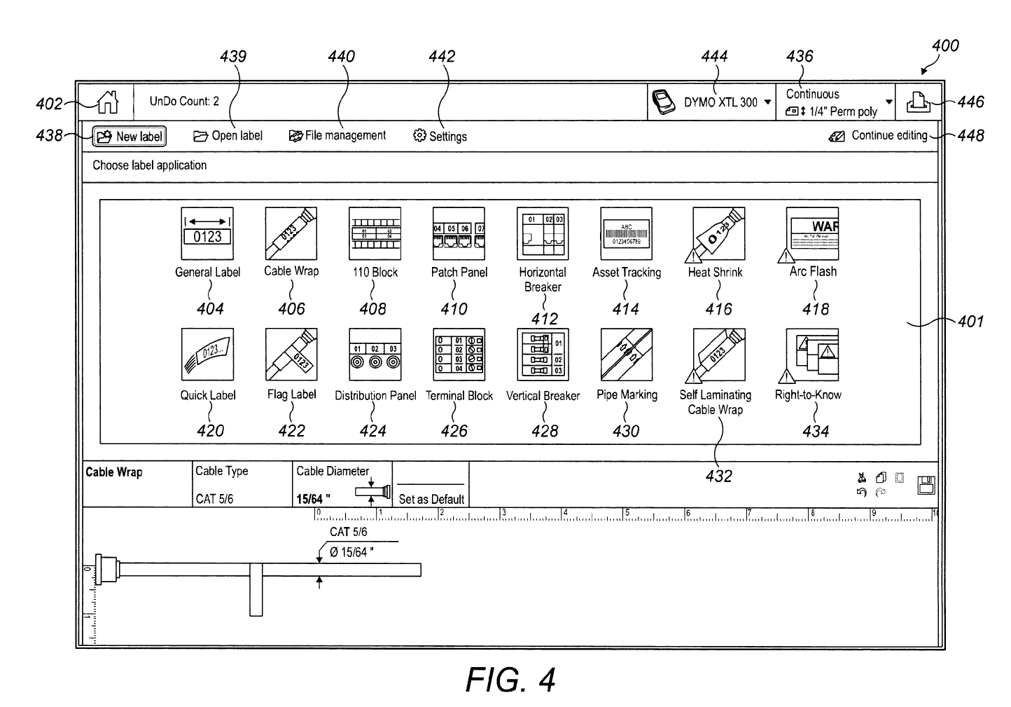

FIG. 4 generally shows a user interface 400 according to an embodiment. The user interface 400 may be presented on a monitor of a PC, on a display of a label printing apparatus or a device to which the label printer is connected. A user can navigate about the user interface 400 by known means. For example the user may operate a mouse or tracker-ball and can select options on the user interface 400 by placing a mouse pointer over an icon and clicking on that icon to select it. However it should also be appreciated that in other embodiments, for example where a touchscreen is used, the user may directly touch the screen or display so as to select icons and enter information. A user may also use a hardware keyboard or the like attached to a PC or directly attached to a label printer for navigating about the user interface.

In the embodiment of FIG. 4 a user has clicked on home icon 402, so that the user is now presented with home screen 401. This presents the user with a number of label types which may be selected by clicking on their respective icon. These label types include a general label 404, a cable wrap label 406, a 110-block label 408, a patch panel label 410, a horizontal breaker label 412, an asset tracking label 414, a heat shrink label 416, an arc flash label 418, a quick label 420, a flag label 422, a distribution panel label 424, a terminal block level 426, a vertical breaker label 428, a pipe marking label 430, a self-laminating cable wrap label 432, and a right-to-know label 434. It should be appreciated that further label types may alternatively or additionally be displayed on the home screen 401. Other examples of label types may comprise safety labels and material management labels.

It should be appreciated that the display may display one or more label types. Those label types may comprise one or more of the label types discussed previously and/or one or more other label types.

The heat shrink label 416, arc flash label 418, self-laminating cable wrap label 432, and right-to-know label 434 are each displayed with an exclamation mark adjacent their icon. This informs the user that these label types are not available in the given context. For example it may not be possible to print these label types on the selected type of label material. The selected type of label material is shown at portion 436 of the user interface 400.

It should be appreciated the label types may be displayed such that the available label types for a given selected label material and/or characteristics and/or size are displayed together. It should be appreciated the label types may be displayed such that the unavailable label types for a given selected label material and/or characteristics and/or size are displayed together. In the example shown in FIG. 4, the available label types may be displayed on the area of the display which is considered to be a first area to be viewed or an area which is considered to contain the most relevant or important information. In the case of a list, this may be at the top of the list. In the case where a left to right alphabet is used, the available options may be displayed on the left of the screen.

The label option types are presented to a user when they click on the “new label” icon 438. In the embodiment of FIG. 4 the “new label” screen also doubles as the home screen.

Other options are also available to a user via user interface 400. These include an “open label” icon 439. By clicking on this icon the user can open a previously saved label. By clicking on “file management” icon 440 the user enters a further interface where the user can manage their saved files, such as renaming the file and transferring the files to and from a label printer. The user can also access a settings menu via icon 442 for changing settings of the user interface. For example the user can change the language setting and whether to use imperial or metric units.

By clicking on icon 444 the user is presented with a drop down list of label printers. The type of label printer selected may for example determine the types of label that are available to a user and/or formatting options available.

Icon 446 is a “quick print” icon which enables a user to quickly print a currently displayed label by clicking on icon 446.

If a user is already in the process of preparing a label, and has exited the label editing screen for any reason, then they can quickly return to editing that label by clicking on “continue editing” icon 448.

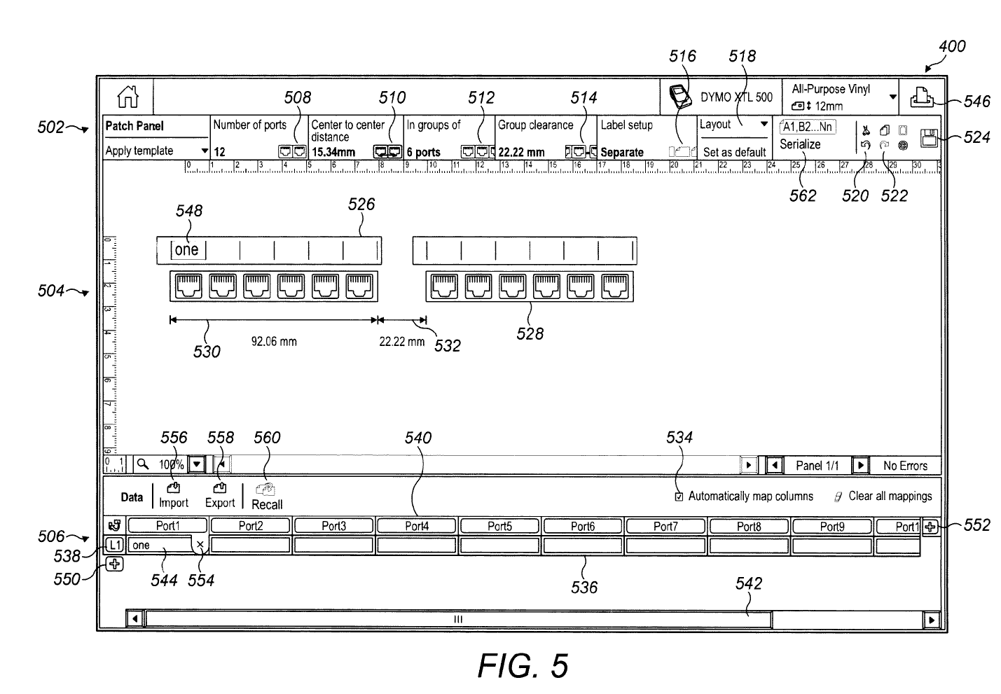

In one example, following selection of the patch panel icon 410 the user interface 400 presents the user with a screen as shown in FIG. 5. On this screen the user interface 400 broadly comprises a format area 502, a label edit area 504, and a data input area 506.

In the format area 502 the user can format properties associated with the selected label type. In this embodiment the user has selected a patch panel label and therefore the options available to the user are related to patch panel labels. For example if a user moves the mouse pointer over the “number of ports” icon 508, then a drop down menu is presented enabling a user to change the number of ports of the patch panel. By selecting “centre on centre distance” icon 510 the user can change the centre on centre distance between the ports of the patch panel. Icon 512 enables a user to select the number of ports per group. Icon 514 enables a user to select the clearance between port groups. Icon 516 enables a user to decide whether they want a continuous label to cover all groups of ports, or a separate label for each port group. The “layout” icon 518 enables a user to select how they would like their label to be laid out, for example whether the user would like separator lines between each label port, or whether they would like to have a label without separator lines.

As discussed above the options available may vary depending upon the type of labels selected.

Icons 520 and 522 enable a user to respectively undo or redo a previous action. Icon 524 enables a user to save the current label.

Icon 546 enables the user to print the current label.

The label edit area 504 shows a preview of the label or labels 526 to be printed. The label preview 526 is shown adjacent a preview of the patch panel 528. The displayed label preview 526 and patch panel preview 528 correspond with the options selected in format area 502. The overall length of each patch panel group is shown adjacent dimension arrow 530. The spacing between patch panel groups is shown adjacent dimension arrow 532.

Data input area 506 will now be described in more detail. Generally speaking information entered into data input area 506 can be mapped or moved to the label being edited in the label edit area 504. A tick box option 534 allows a user to decide whether to automatically map information from data input area 506 to the label 526 in label edit area 504. In this example the user has ticked the “automatically map columns” box 534. In other embodiments other means may be employed for enabling a user to select whether to automatically map information, such as a drop-down menu or any other kind of menu. In another embodiment no option is provided, and the data is automatically mapped.

The data input area 506 comprises a table, or data grid, labelled 536. The table consists of rows 538 and columns 540. In this example the header of each column is a port number associated with a port on the patch panel 528. Each row 538 corresponds with a label number, such that information relating to more than one label can be displayed in the data input area at any one time. This is explained in more detail further below.

In this example a patch panel with 12 ports has been selected. It is not possible to display information relating to this number of ports in the data input area 506 simultaneously. Accordingly a scroll bar 542 is provided, which enables a user to navigate around the data input area 506 to see all information.

A user can input data into data input area 506. In this example the user has typed the word “One” into cell 544 of table 536. As shown by the table header, this cell is associated with Port 1 of the patch panel. Accordingly, the word “One” is shown in region 548 of the label 526, which is adjacent Port 1 of patch panel 528. Since the auto-mapping feature has been selected in box 534 this word is automatically mapped to the label 526 when it is typed into the data input area 506.

In this example the user clicked on the “Port 1” header to begin typing into cell 544. This action of selecting header “Port 1” has caused the corresponding region 548 of label 526 to be darkened relative to adjacent portions of the label. In embodiments this may occur even before data is entered into cell 544. This allows a user to easily see which portion of the label they are working on.

It should be appreciated that whenever a cell and/or header is selected or pointed at, the corresponding label region is highlighted. In some embodiments, whenever, a label region is selected or pointed at, the corresponding cell and/or header is highlighted.

In some embodiments, if a cell is selected or pointed at the corresponding header may be highlighted and/or vice versa.

The highlighting can take any form, such as use of a different color, shading, a flashing background etc.

In some embodiments the header and/or label region is highlighted when clicked upon or selected by a user. The header and/or label region may also be highlighted if hovered over by a mouse pointer or other selection means.

The user can add and remove rows and columns from the data input area 506. This process may be carried out in any way. In this example a new row can be added by clicking on “+” icon 550. Once this new row has been added it can also be deleted by clicking on a corresponding “x” icon which appears when that row number is hovered over. A new column can be added by clicking on “+” icon 552. A column can be deleted by hovering over the header of that column which will then display a cross (“x”), which if clicked will cause that column to be deleted. For example in FIG. 5 the user has hovered their mouse pointer over “Port 1”, causing a cross icon 554 to appear. If the cross 554 is clicked then the “Port 1” column will be deleted.

The user interface 400 also comprises some further functions which will be described in more detail later. For example by clicking on icon 556 the user can import data from an external source. By clicking on icon 558 the user can export data to an external source. By clicking on icon 560 the user can recall previously stored data. By clicking on icon 562 the user can define a serialized pattern of data to be entered.

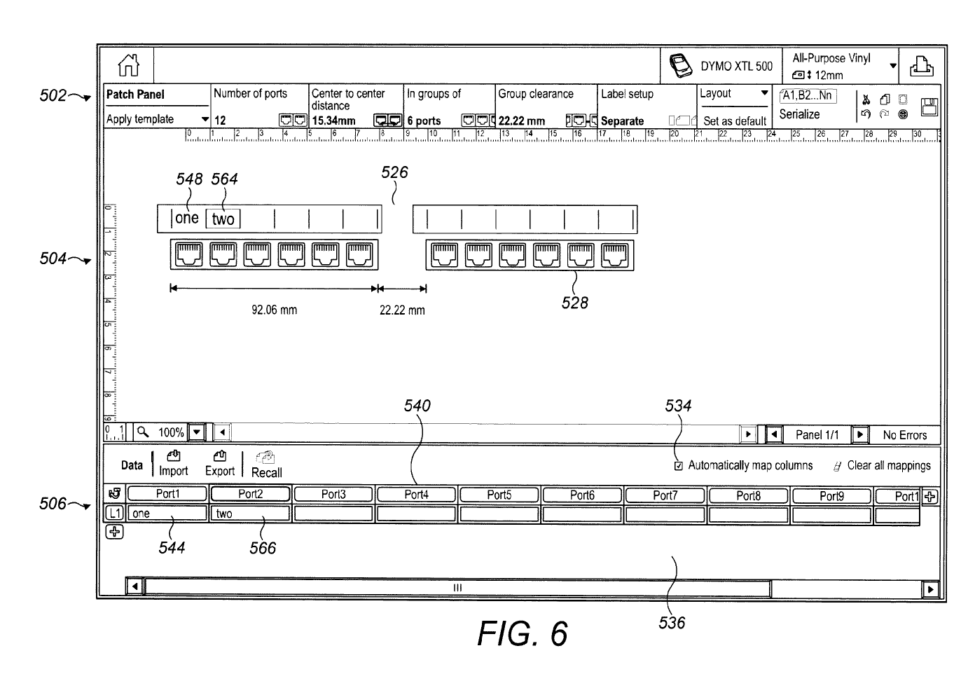

FIG. 6 shows a progression of the data entry from FIG. 5. In this example the user has continued to enter further data. The user has clicked on or selected header “Port 2” in the data input area 506, and the region 564 of label 526 is highlighted, to show that this region of the label is being worked on (i.e. the second port). Likewise the header region in the data input area 506 surrounding the wording “Port 2” and/or the corresponding cell is highlighted to show that this is the selected port. Regions of the image of the label 526 that are mapped to cells in the table 536 are therefore correspondingly highlighted.

In some embodiments a region in the table 536 can be mapped with several label fields in the label edit area 504 and in the label image 526. In such a case, when a user hovers over or selects a cell in the table 536, then more than one region of the label 526 in the label edit area will be highlighted, along with the highlighting of the selected or hovered over cell. The selecting or hovering over of a cell or region of the label image may generally be termed “specifying” that cell or region of the label.

The user then enters the word “Two” into cell 566, which causes a corresponding entry of the word “Two” in region 564 of label 526.

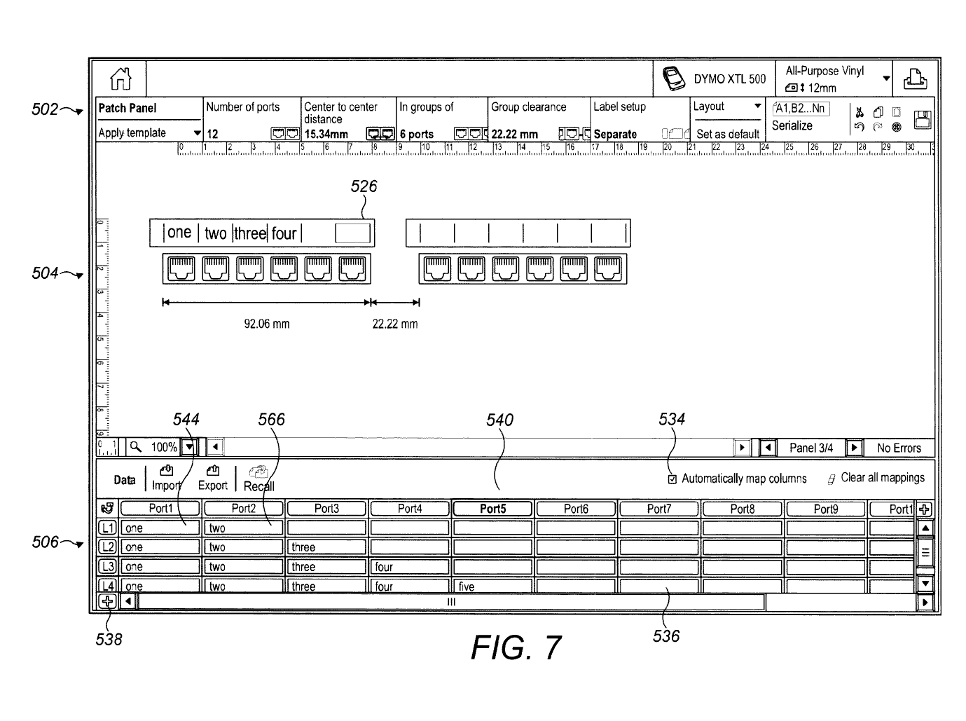

FIG. 7 is a progression of the label creating process shown in FIG. 6. In FIG. 7 the user has inputted data for two further labels. There are therefore four labels labelled L1 to L4 respectively. Label L1 comprises the words “One”, “Two”, for Port 1 and Port 2 respectively. Label L2 comprises the words “One”, “Two” and “Three” for Ports 1 to 3 respectively. Label L3 further comprises the word “Four” for Port 4 respectively. Label L4 further comprises the word “Five” for Port 5 respectively. These further labels have been added by clicking on plus icon 538.

In the example of FIG. 7 the user has clicked on row L3. Accordingly this row is highlighted in table 536 for example, by the highlighting of the borders of the cells in row L3. The highlighting may take any other suitable form. Also, since this row has been highlighted, the information relating to this row is shown in label preview 526. If the user were to select row L4, then the data relating to that row would be represented in label preview 526, and so on. For each cell in the table that is left blank, then the corresponding port in the label preview 526 is also left blank.

It will be appreciated that each row may relate to data for a single label. Each cell may determine the position of that data on the label. Alternatively data in different cells in the same row may relate to different labels within a group of labels. This may be the case for a patch panel label comprising a plurality of labels, for example. Which cells belong to which label within the group may be determined by the user when setting the properties of the patch panel.

It will also be appreciated that the cells of each column may relate to the position of data in separate labels. In other embodiments each column may relate to data for a single label. For example different cells in the same column may relate to different lines of a multi-line label.

As discussed previously the user can also move information from the table 536 to the label preview area 504 by dragging and dropping the information between the two areas. This can be done if the auto-map columns box 534 is un-ticked. The user can then select the header for the data in the table 536 that they wish to move (e.g. “Port 1”, “Port 2” etc.), and then drag the data associated with that header into the relevant portion of label 526.

For example, with respect to FIG. 7 the user could select the header “Port 4”. Remembering that in the example of FIG. 7 row 3 has been selected (and its border highlighted), the data associated with row 3, port 4 is the word “Four”. Thus, by selecting the header “Port 4” the user can drag and drop the word “Four” in to any of the ports on the label preview. Dragging and dropping is one example of how the information can be moved between the two areas. Alternatively, the user can click once on the header in the table 536, then when the user clicks on a portion of label preview 526, then that information is transferred to the portion of the label preview 526 that was clicked upon.

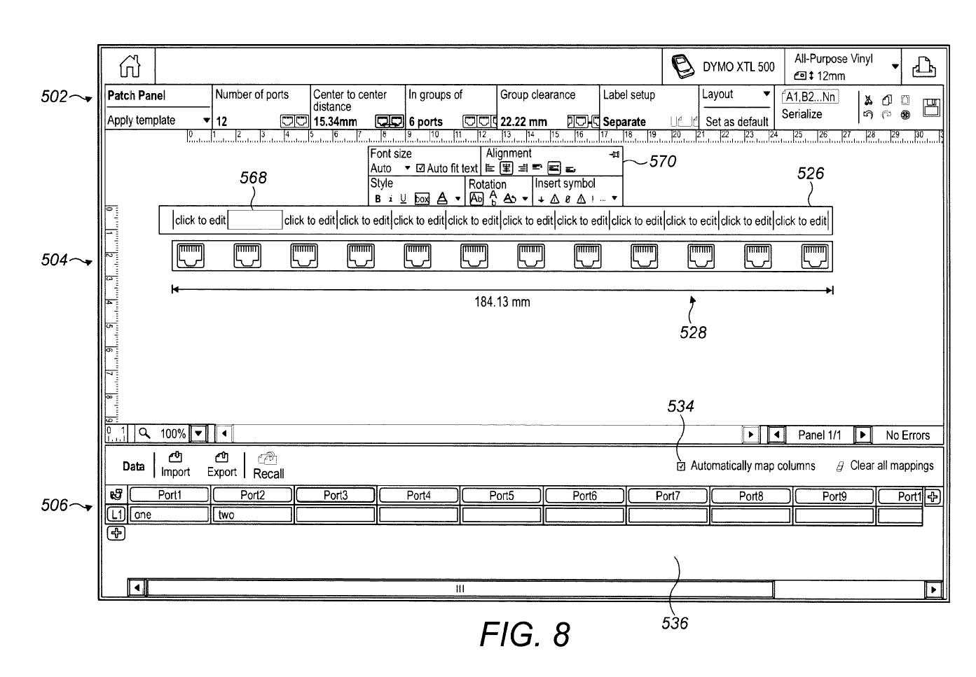

As shown in FIG. 8 a user can also enter data directly into the label preview 526 in the label edit area 504. In FIG. 8 the user has clicked on the label preview 526 adjacent the third port. This has caused a text box 568 to open adjacent the third port, as well as a format option box 570. The user can then enter text or characters into the text box 568.

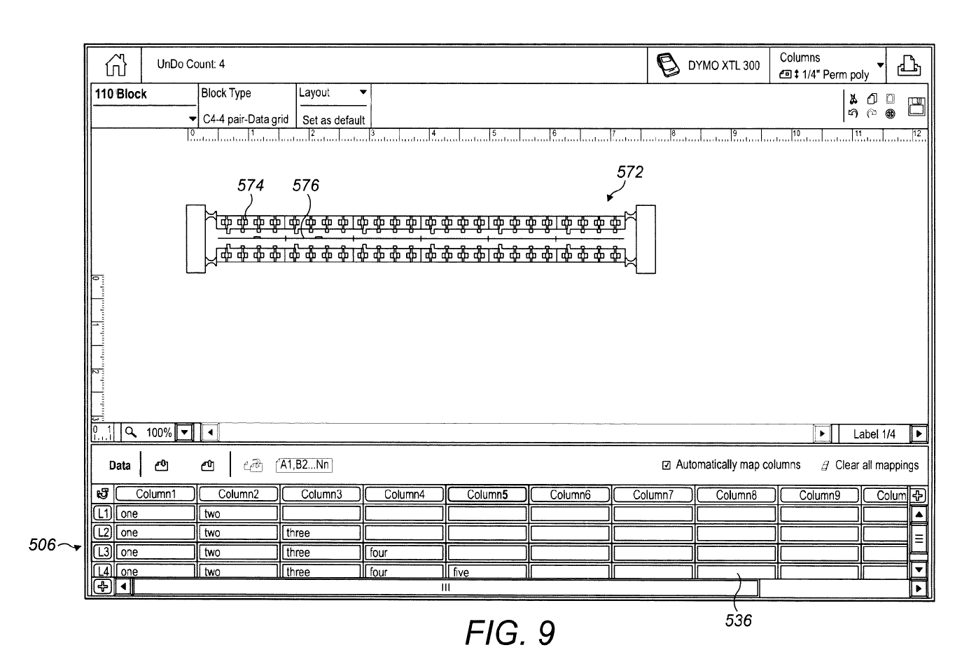

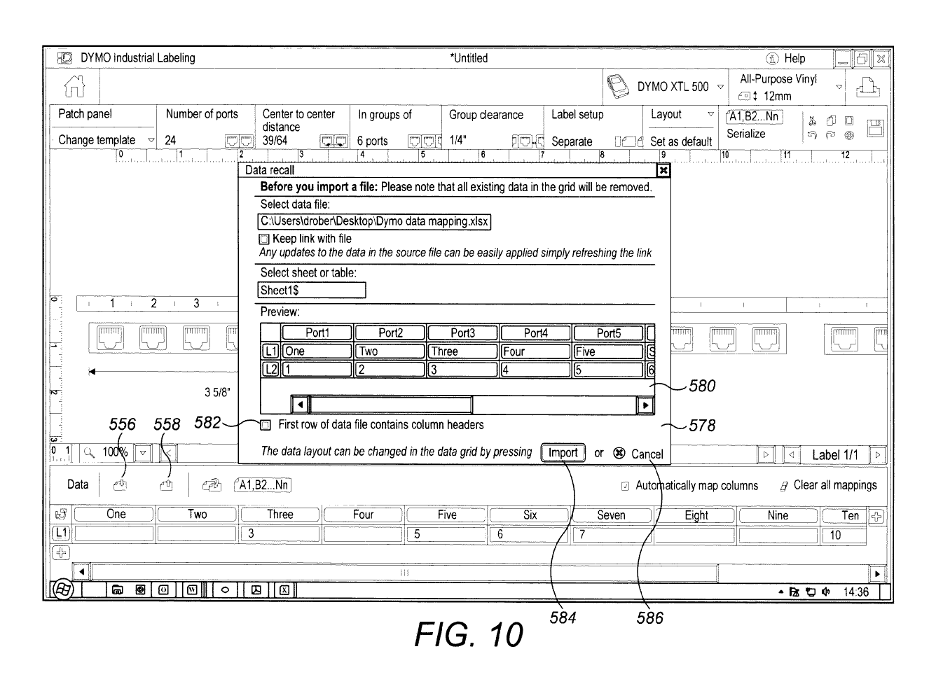

As discussed above the concept of the data entry area 506 comprising a table 536 can be applied to any type of label, not just the example of the patch panel given above. In FIG. 9 the user has selected a 110-block type label. This is shown in label preview 572. The user has selected or specified label one i.e. row L1, the borders of which is accordingly highlighted. This row consists of the word “One” in column 1, and the word “Two” in column 2. These words have been mapped to regions 574 and 576 of the label preview 572. If any of the other labels L2 to L4 were to be selected, then the data associated with those labels would be shown in label preview 572.

In some embodiments the data displayed in the label preview area 504 can only be edited in the table 536. This may be applicable to all label types.

As discussed above, a user may import data from an external source so as to enter that data into the labels to be printed. The data may be imported in any fashion. In the example shown the user begins the importing step by clicking on import icon 556 as discussed with respect to FIG. 5. When this icon has been selected a pop-up window 578 appears which enables a user to browse files which they may wish to import into the data entry area 506. In this example the user is about to import data from an external spreadsheet entitled “Dymo data mapping.xlsx”. A preview of the data to be imported is shown in region 580 of pop-up 578. The user is also provided with some options. For example the user can decide whether the first row of the data in the file is to constitute the column headers in the data input area 506, once imported. This is done by checking box 582. In this example the box 582 is unchecked. However if this box is checked then the terms “One”, “Two”, “Three”, “Four”, and “Five” would replace the wording “Port 1”, “Port 2”, “Port 3”, “Port 4”, and “Port 5” respectively in the headers and so on. If the user wishes to import this data then they can click on the “Import” button 584. Alternatively if the user has decided that they do not want to import this data then they can click on the cancel button 586.

The user can also export data to an external source in a similar manner by clicking on the icon 558. The data may also be exported in any other fashion.

As previously discussed a user can enter a serialized pattern of data. A user can choose to begin the process of preparing serial labels by clicking on the serialization icon 562 (see FIG. 5). It should be noted that the serialization icon 562 may be available when editing any type of label, not just the patch panel label as shown in FIG. 5.

For example a user may have decided to prepare a general label by clicking on icon 404 on the home screen 400 (see FIG. 4). The user may then click on the serialization icon 562 to prepare a series of general labels.

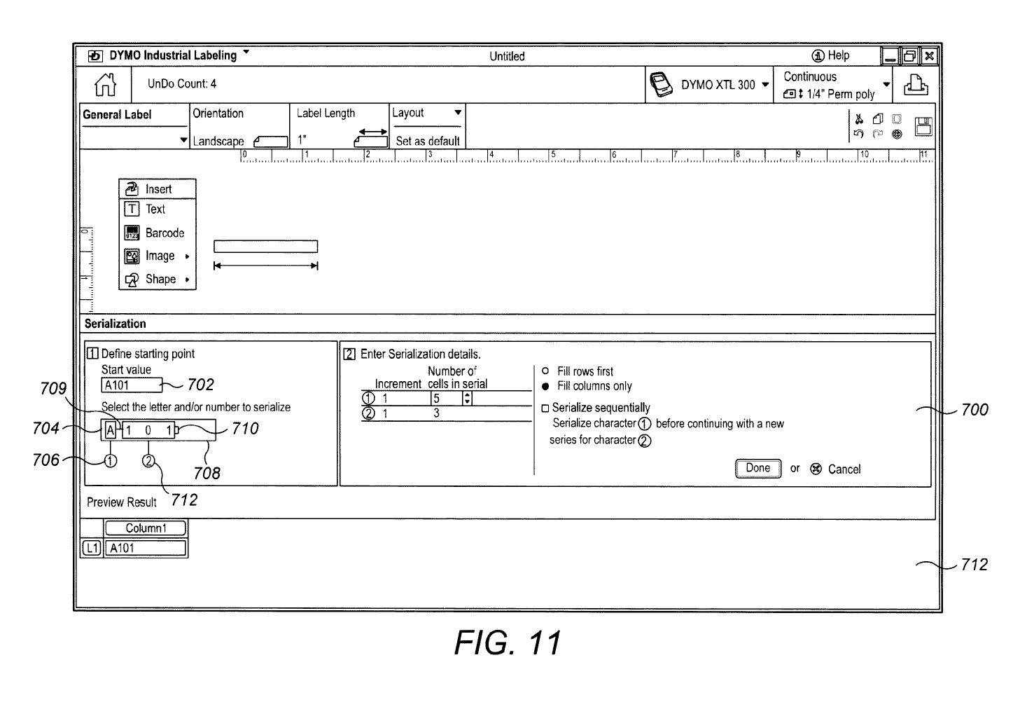

FIG. 11 shows an example of an options screen 700 or “wizard” which is presented to a user following the selection of the serialization icon. The options screen 700 provides a step-by-step process for creating serialized data, which makes it easy for a user to prepare a series of labels. The first step is for the user to enter the start value of the series. The user enters this value in the box 702. In this example the user has entered “A101” as the start value.

The user can then select which portion or portions of the start value they wish to serialize. In this example the user has clicked on the letter “A” to show that this is the first value that they wish to serialize. The letter “A” is accordingly surrounded by a box 704, connected to which is a tag with the number “1” 706 to clearly show to the user that this is the first character which will be serialized.

In this example the user has then clicked on the first instance of the number “1” in the start value “A101”. This generates a box 708 having handles 709 and 710 at either end thereof. The user can click on and drag these handles to select more or fewer characters from the start value that they wish to serialize. In this example the user has clicked on and dragged the handle 710 such that the entire value “101” is selected as the second value that will be serialized. This is shown with tag 712 appended to box 708, showing that this is the second value to be serialized. It should be appreciated that when the user selected the letter “A”, the box 704 also comprised handles at either side for enabling a user to alter the size of box 704 to include more or fewer characters.

Below the options screen 700 is a preview screen 712. The preview screen provides a preview of the serialized data.

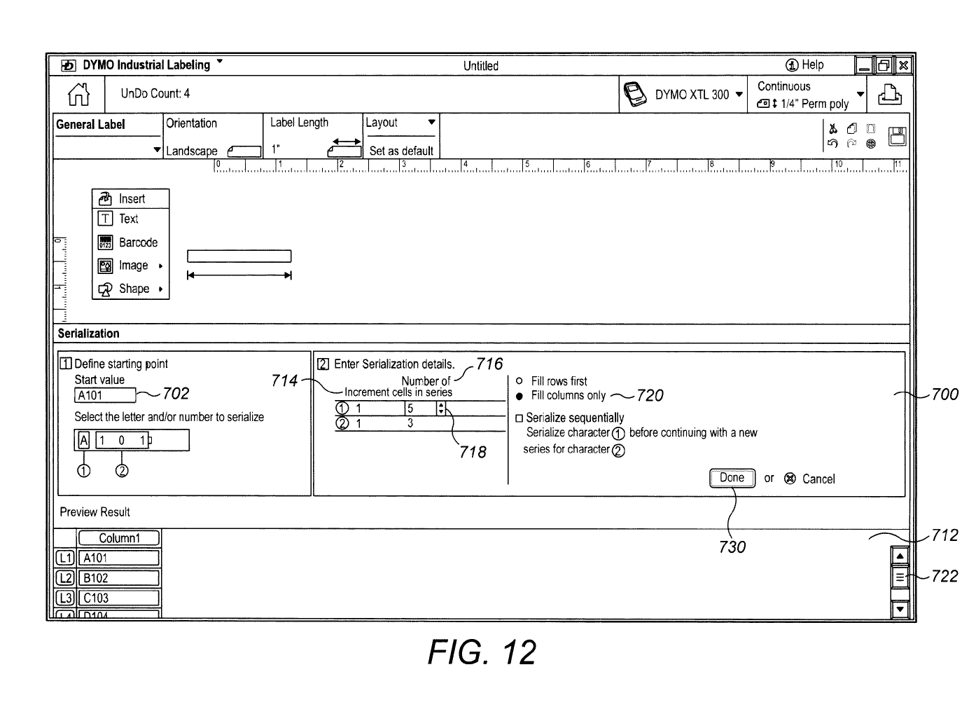

The next step, as shown in FIG. 12, is for the user to enter the serialization details. This allows the user to set the increments 714 and the number of cells in the series 716. The user can do this for each aspect of the data being serialized. The values for the increments 714 and the number of cells in the series can be adjusted by use of up and down arrows in a box 718 which appears when the user clicks on either of the “Increment” or “Number of cells in series” variables. As shown in FIG. 12 the user has set the increment for the first variable (i.e. “A”) to 1. The user has set the increment for the second variable (i.e. “101”) to 1. The number of cells for this series has been set at 5. The user has also chosen the option to “fill column only” as opposed to “fill rows first” as shown at 720.

A preview of the serialized pattern of data is shown at 712. The preview shows a column of labels serialized as set in the options region 700. That is the first label in the series is A101, the second label L2 is B102, and the third label is C103 etc. There is insufficient space in the preview region to display all of the labels in the series, and therefore a scrollbar 722 is provided which enables a user to scroll through the labels in the label preview.

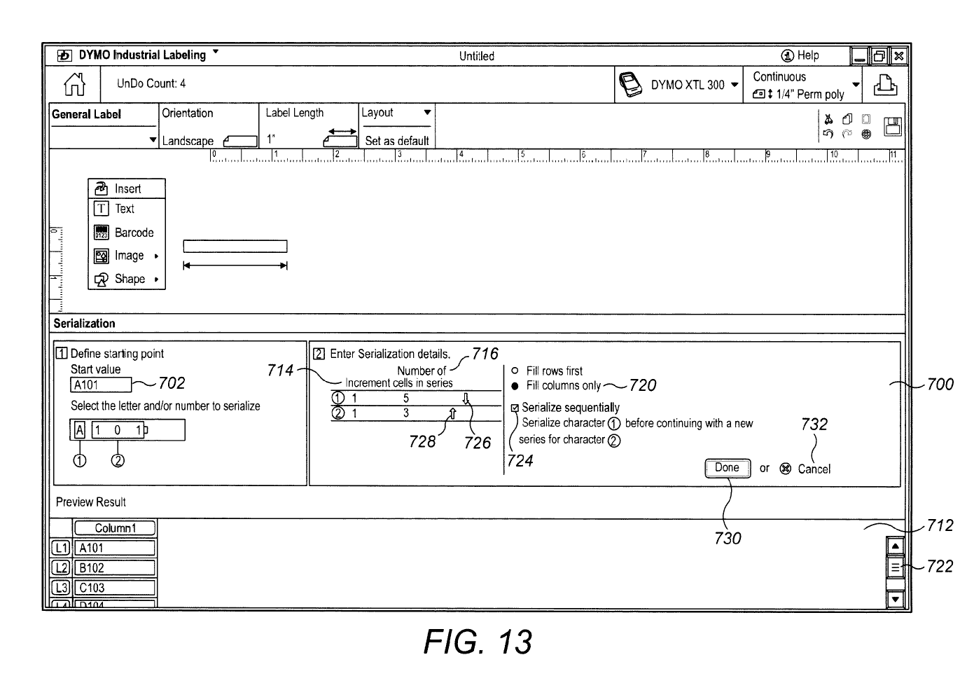

As shown in FIG. 13, another option available to the user is to select whether to serialize the data sequentially. The user can tick box 724 if they wish to serialize the data sequentially. This option is particularly useful if there is more than one aspect or character of the data that is being serialized. This option allows the user to set which character is to be serialized first. Therefore by ticking this option the user has selected that they wish to serialize the letter “A” before the number “101” is serialized, i.e. the labels will be serialized as shown in the preview region 712 as A101, B101, C101, D101, E101, A102, B102, C102 etc.

When the “serialize sequentially” box 724 is ticked, arrows 726 and 728 appear in the “enter serialization details” region of option screen 700. This enables the user to change the character in question from being character “1” to character “2”. For example if the user clicked arrow 728, then the number “101” would become the first character in the serialization list to be serialized; and the series of labels shown in preview region 712 would become A101, A102, A103, A104, A105, B101, B102 etc.

If the user has completed entering information into the options area 700 and wishes to continue, they can do so by pressing the “done” button 730. Alternatively the user can cancel the serialization procedure by pressing the “cancel” button 732.

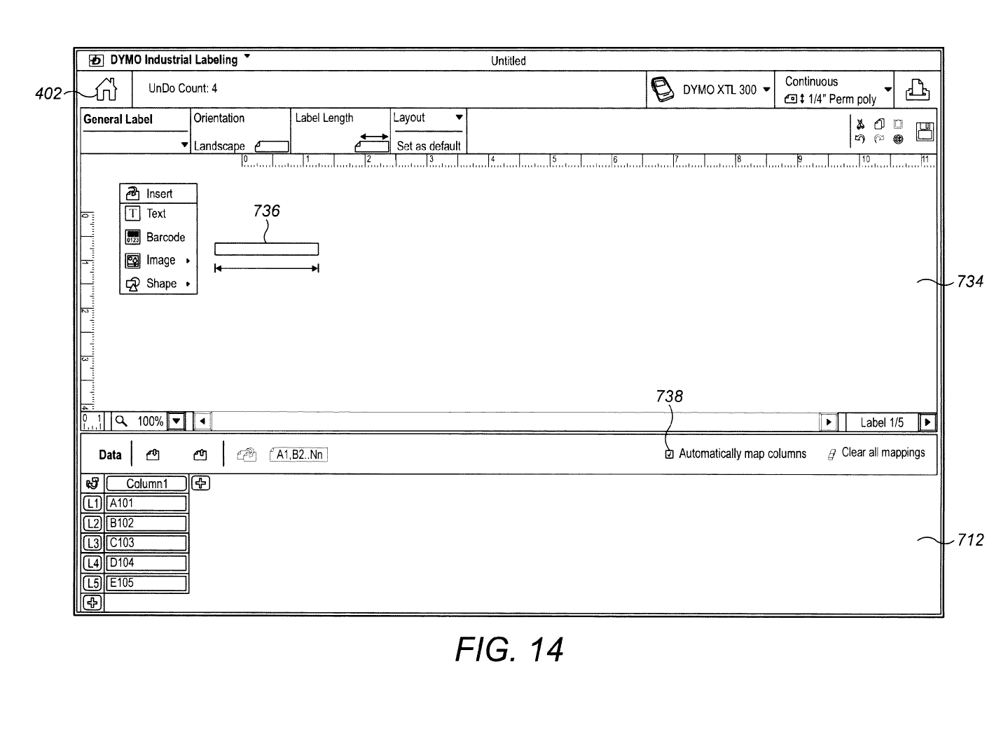

Following on from FIG. 12, if the user presses the “done” button 730 then the user interface will revert to the interface as shown in FIG. 14. The user interface now shows a label edit area 734 above the label preview area 712. The label edit area 734 comprises an image of a label 736. As previously explained the user can drag-and-drop (or select in any other way) information from the label preview area 712 into the label 736. Alternatively the user can click on the auto map columns button 738 to automatically map the serialized data to the label image 736.

It will be appreciated that the serialized data can be transferred to the table in the preview area 712 so as to populate one or more columns, one or more rows, or one or more rows and columns simultaneously.

The above method is particularly user friendly. It enables a user, with minimum effort, to enter a large amount of data for labels to be printed. The interface provided is particularly intuitive and therefore easy for a user to use without any training.

The serialization options screen 700 or “wizard” guides the user through the entire serialization process and provides the user with a preview of the serialized data before completing the serialization process. This allows the user to create large amounts of data with relatively few clicks, and the preview function minimizes data input errors.

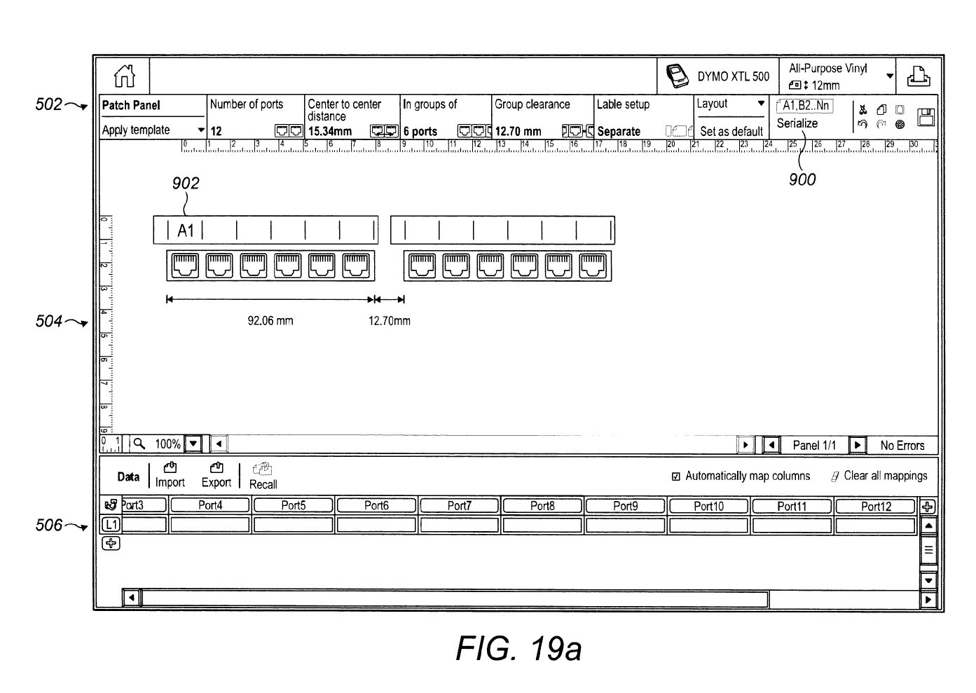

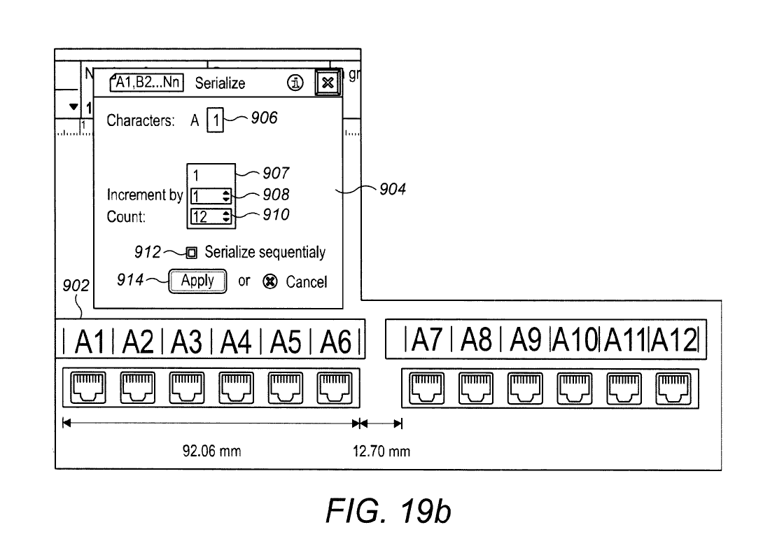

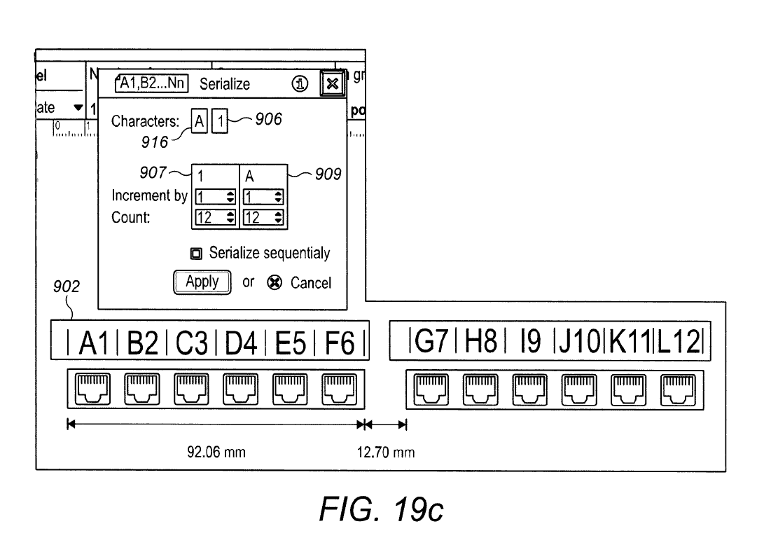

Reference is made to FIGS. 19a to 19c which show an alternative embodiment for serialization of data. In FIG. 19a, a patch panel option is shown similar to that previously discussed in relation to FIGS. 5 to 7. As can be seen, there is a serialize option 900 which is provided in the format area 502.

FIG. 19b shows a serialize menu 904 which is displayed when the user has clicked or otherwise selected the serialize option. This may be displayed at least partially in in the label edit area. The menu may be displayed adjacent the preview of the label or labels to be printed.

The serialize option may optionally select as a default one of the characters to serialize. In the example shown, the last character is selected as the character to be serialized. In some embodiments, the first character is selected as the initial character to be serialized. In some embodiments, the first character which is a number is selected as the character to serialize. In some embodiments, all of the characters are initially selected to serialize. In some embodiments, there is no default selection and the user will be prompted to select one or more characters to serialize.

To demonstrate to the user which character is being serialized, that character will be highlighted or marked in any suitable manner. In some embodiments, a box may be provided around the character being serialized. For the character being serialized, an option menu 907 may be displayed. This will indicate one or more of the character being serialized, the increment value 908 and the count value 910. In the example of the FIG. 19b, the character being serialized is “1”, the increment value is “1” and the count is “1”.

Reference is made to FIG. 19c, in which the user has selected a second character “A” to be serialized. This may be achieved by the user, clicking or otherwise selecting the second character. A second option menu 909 may be displayed which has the same options as the first menu but for the second selected character. Thus each label will have both the first and second characters incremented in successive labels to give A1, B2, C3 etc.

An option 912 of serializing sequentially is provided. If this option is selected, then one of the selected characters is kept the same, while the other of the characters is incremented to its maximum. The one of the selected characters is then incremented and the other of the characters is then successively incremented to its maximum.

For example: A1 is the initial value. Each character has an increment value of 1 and a count value of 3. This would give the following labels:

A1, A2, A3, B1, B2, B3, C1, C2, C3.

It should be appreciated that in some embodiments a value can be decremented instead of incremented. Alternatively “decrementing” may be dealt with be the use of negative numbers.

It should be appreciated that a grid may be provided as previously described. In some embodiments, the user may alternatively or additionally be able to select the serialize option when in the data input area 506 and serialize using the data in a cell.

Another option available to a user is the “recall data” function. This function enables a user to recall data for a previously created label and to insert it into a new label. For example a user may have created a set of data for a general label such as shown in FIG. 14. The user may then decide that they wish to use the same data for creation of a flag label or a series of flag labels. The user can first return to the home screen by pressing home button 402. From the home screen the user can then begin preparation of a flag label by clicking on flag label icon 422.

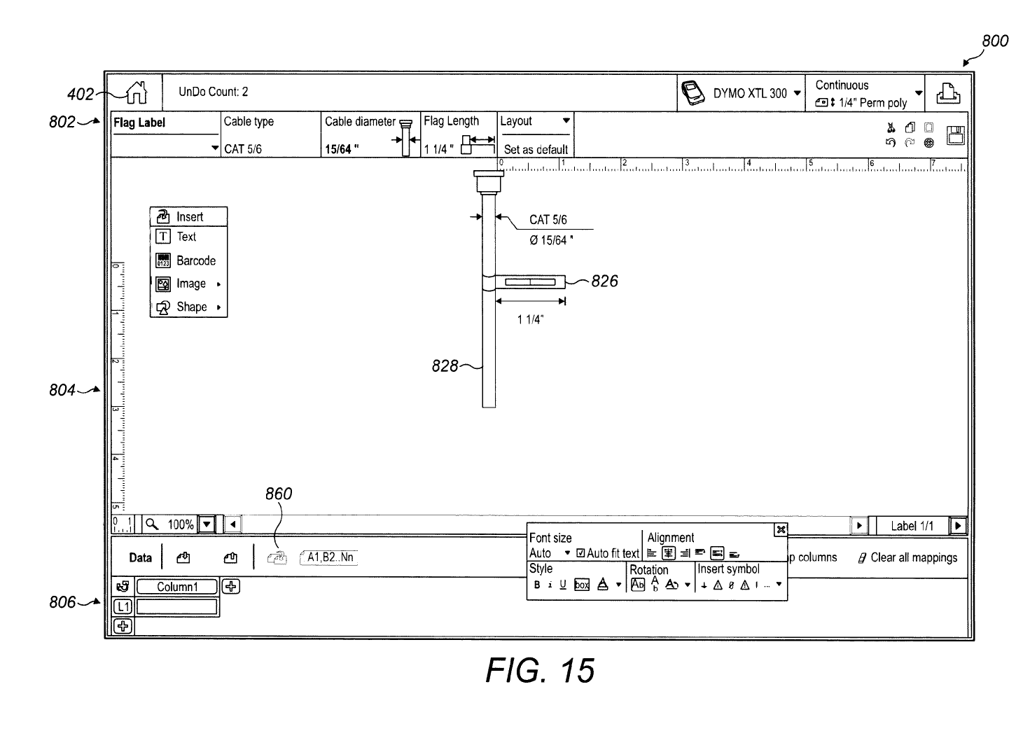

The user will then be presented with a user interface as shown in FIG. 15 for preparing a flag label.

The user interface 800 comprises, similarly to FIG. 5, a format area 802, a label edit area 804, and a data input area 806. The preview of the flag label 826 is shown as it would appear when attached to an object 828 such as a cable.

The user can then recall previously saved data by clicking on recall icon 860.

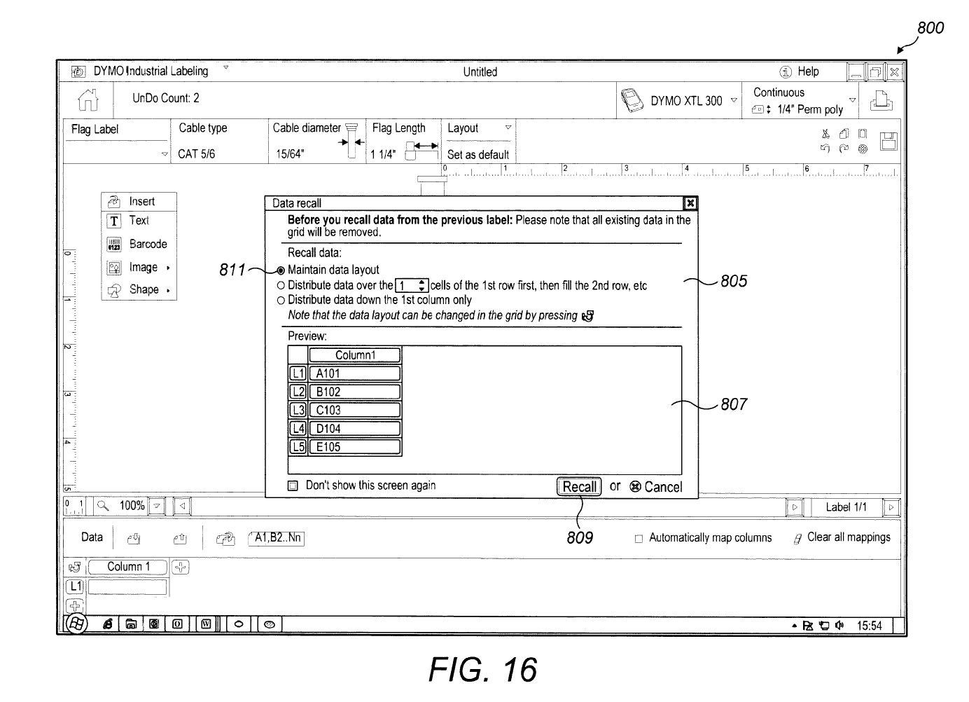

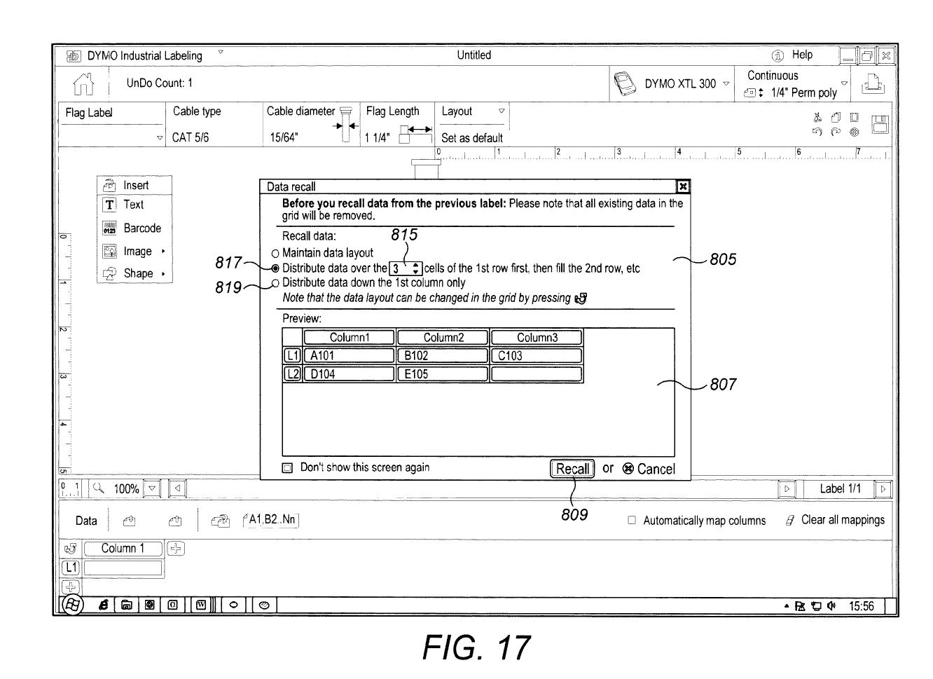

The user interface 800 then updates to show the user an options screen 805 (see FIG. 16) relating to data from the previous label i.e. the general label as shown in FIG. 14. In other embodiments the user may also be able to recall data from any other saved label, not just the previous label.

The options screen 805 comprises a preview region 807 which displays how the recalled data will look when recalled into the data input area 806. The user can choose to recall this data by pressing “Recall” button 809.

Prior to recalling the data into the data input region 806, the options screen 805 allows the user to decide the layout of the data. In FIG. 16 the user has selected to maintain the same data layout, as shown at 811.

As shown in FIG. 17 the user may also choose to modify the distribution of the data. As shown at 813 the user has, using up and down arrows in box 815, decided to distribute the data over the three cells of the first row first, then to fill down the second row etc. The box 815 is enabled by initially clicking on button 817.

The user could also click on button 819 which would cause the data to be distributed down the first column only i.e. all data recalled to be recalled into a single column.

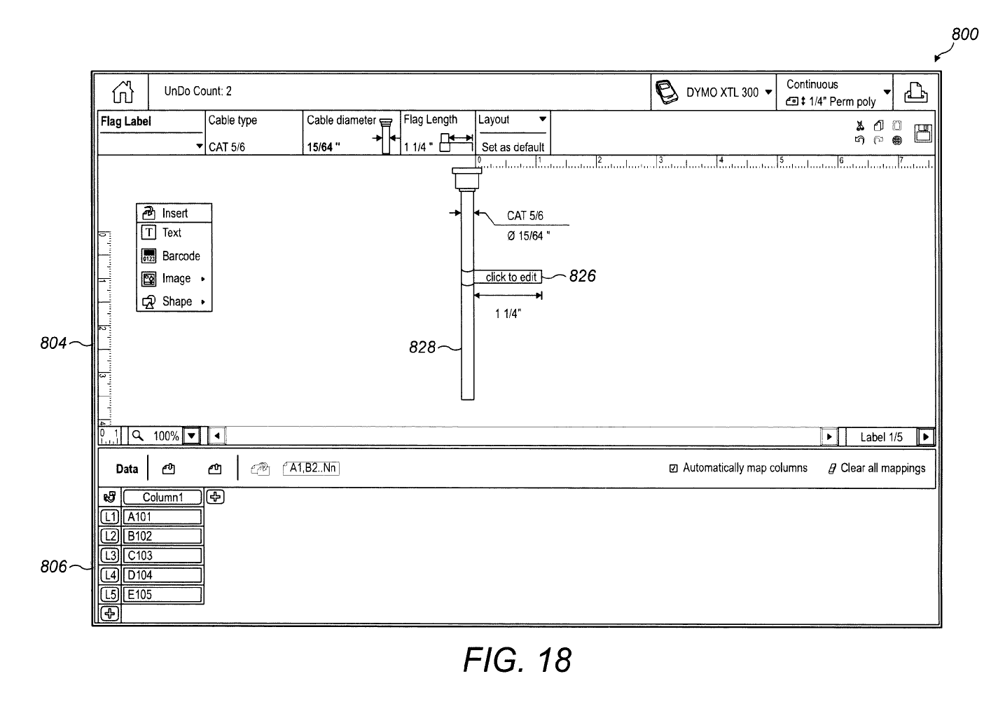

Following on from FIG. 16, if the user presses the “Recall” button 809 then the user interface 800 updates as shown in FIG. 18. The label edit area 804 displays the label 826 and object 828 preview. The data input area 806 has been updated to show the recalled data, as per the preview shown in FIG. 16. This data can then be mapped into the label 826 either by using the auto mapping feature or by dragging and dropping (or selecting in another way) the label data into the label 826.

Although recalling of data from a general label to a flag label has been shown, it should be appreciated that label data can be recalled between other types of label e.g. between a 110 block label and a patch panel label. In some embodiments, before recalling the data a determination may be made to determine whether the recalled data is compatible with the new label type. If not, a warning may be provided to the user.

The skilled person would appreciate that any of the methods described herein may be implemented using a computer program embodied on a computer readable medium (such as a CDROM or memory within a stand-alone printer) for controlling a controller (or other similar apparatus as discussed above).

Embodiments may be used with continuous tape or die cut labels. Die cut labels are provided on a continuous backing layer but are discrete, pre-cut labels. The tape or die cut labels may be provided in a cassette or simply on a roll.

The foregoing merely illustrates the principles of certain embodiments. Modifications and alterations to the described embodiments will be apparent to those skilled in the art in view of the teaching herein. It will thus be appreciated that those skilled in the art would be able to devise numerous techniques which although not explicitly described herein, embody the principles of the described embodiments and are thus within the scope defined by the claims.

1. A method comprising:
providing in a first region of a user interface a label preview region for displaying an image of at least one label to be printed;
providing in a second region of the user interface a data input area comprising two or more cells for input label data;
wherein each cell in the data input area corresponds with the image of at least one label to be printed or at least one region of the image of at least one label to be printed;
and providing an information input area, said information input area enabling a user to enter information for defining a serialized pattern of data for at least one label to be printed; wherein said method comprises populating each of said two or more cells with a portion of said serialized pattern of data.

2. The method as set forth in claim 1, wherein the method comprises mapping data entered in the data input area to the corresponding image of at least one label to be printed or at least one region of the image of at least one label to be printed.

3. The method as set forth in claim 2, wherein the mapped data is located in said image of at least one label to be printed or at least one region of the image of at least one label to be printed in dependence on the cell corresponding with that data.

4. The method as set forth in claim 1, wherein the method comprises transferring, in response to an input via a user-input, data entered in the data input area to the corresponding image of at least one label to be printed or at least one region of the at least one label to be printed.

5. The method as set forth in claim 4, wherein the user-input comprises a dragging and dropping operation.

6. The method as set forth in claim 1, wherein when a cell is specified via a user input, at least one of that cell, and the corresponding image of at least one label or at least one region of the image of the at least one label, are highlighted.

7. The method as set forth in claim 1, wherein when the image of at least one label or at least one region of the image of the at least one label is specified by an input to a user input, at least one of that image of at least one label or at least one region of the image of the at least one label, and a corresponding one or more cells, are highlighted.

8. The method as set forth in claim 6, wherein said highlighting comprises at least one of a coloured background, a shaded background, a flashing background.

9. (canceled)

10. The method as set forth in claim 1, wherein the two or more cells are arranged in a table structure comprising rows and columns, wherein one of each column and each row corresponds with one label or group of labels.

11. (canceled)

12. The method as set forth in claim 1, wherein the two or more cells are arranged in a table structure comprising rows and columns, each column being provided with header information.

13-16. (canceled)

17. A computer program comprising computer program code means adapted to perform the method according to claim 1 when said program is run on a computer.

18. An apparatus comprising:
a controller configured:
to output, to a display driver, data for causing the display driver to drive a display to display in a first region of a user interface a label preview region for displaying at least one label to be printed;
and to display in a second region of the user interface a data input area comprising two or more cells for input label data;
wherein the controller is configured to correspond each cell in the data input area with the image of at least one label to be printed or at least one region of the image of the at least one label to be printed;
and wherein the controller is configured to provide an information input area, said information input area enabling a user to enter information for defining a serialized pattern of data for at least one label to be printed, and to populate each of said two or more cells with a portion of said serialized pattern of data.

19. The apparatus as set forth in claim 18, wherein the controller is configured to map data entered in the data input area to the corresponding image of at least one label to be printed or at least one region of the image of at least one label to be printed.

20. The apparatus as set forth in claim 19, wherein the controller is configured to locate the mapped data in said image of at least one label to be printed or at least one region of the image of at least one label to be printed in dependence on the cell corresponding with that data.

21. (canceled)

22. The apparatus as set forth in claim 18, wherein when the image of at least one label or at least one region of the image of the at least one label is specified by a user, the controller is configured to highlight at least one of that image of at least one label or at least one region of the image of the at least one label and a corresponding one or more cells.

23. The apparatus as set forth in claim 18, wherein the controller is configured to cause the two or more cells to be displayed in a table structure comprising rows and columns, each column being provided with header information.

24. The apparatus as set forth in claim 18, wherein the controller is configured when a cell is highlighted to cause the corresponding column header to be highlighted.

25. (canceled)

26. The method as set forth in claim 1, wherein the serialized pattern of data comprises two or more characters, and the method comprises highlighting a character or characters to be serialized of the two or more characters.

27. The method as set forth in claim 9, wherein an option menu is provided which indicates one or more of: the character or characters being serialized; an increment or decrement value for the serialized pattern of data; a count value for the serialized pattern of data.

28. The apparatus as set forth in claim 14, wherein the pattern of data comprises two or more characters, and the controller is configured to provide an option of serializing sequentially whereby one of the two or more characters is serialized whilst another of the two or more characters is kept constant.
